(19) United States
(12) Patent Application Publication
(10) Pub. No.: US 2008/0136745 A1
(43) Pub. Date: Jun. 12, 2008

(54) PLASMA DISPLAY AND DRIVING METHOD THEREOF

(76) Inventor: Kunio Takayama, Yongin-si (KR)

Correspondence Address: CHRISTIE, PARKER & HALE, LLP, PO BOX 7068, PASADENA, CA, 91109-7068, US

(21) Appl. No.: 11/928,919

(22) Filed: Oct. 30, 2007

(30) Foreign Application Priority Data
Dec. 12, 2006 (KR) 10-2006-0126256

(51) Int. Cl. G09G 3/28

(52) U.S. Cl. 345/60

(57) ABSTRACT

A plasma display including a PDP and a driving method. High PDP temperatures and high load ratios impair the sustain discharge operation by creating uncontrollable charges that create a weak discharge during the address period. Subfields are rearranged to place a subfield having a weight lower than a reference weight between subfields having weights greater than the reference weight when the temperature of the PDP exceeds a reference temperature. The load ratio of at least one subfield is detected from an input video signal of one frame, and the subfields are rearranged when either the detected temperature is greater than the reference temperature or the detected load ratio is greater than a reference load ratio, or both. Uncontrollable charges are hence maintained below a threshold level and the weak discharge is reduced.

### CROSS-REFERENCE TO RELATED APPLICATION

This application claims priority to and the benefit of Korean Patent Application No. 10-2006-0126256 filed in the Korean Intellectual Property Office on Dec. 12, 2006, the entire content of which is incorporated herein by reference.

### BACKGROUND OF THE INVENTION

1. Field of the Invention

The present invention relates to a plasma display and a driving method thereof and, more particularly, to a plasma display device display with reduced generation of weak discharge that occurs due to high temperature of the plasma display, and a driving method thereof.

2. Description of the Related Art

A plasma display is a flat panel display device that uses plasma generated by a gas discharge process to display characters or images, and includes a large number of pixels arranged in a matrix format.

Generally, in a plasma display, a field is divided into weighted subfields, and each subfield includes a reset period, an address period, and a sustain period. The reset period is for initializing the status of each discharge cell to facilitate an addressing operation on the discharge cell, and the address period is for selecting turn-on/turn-off cells (i.e. cells to be turned on or off) and accumulating wall charges in the turn-on cells (i.e. addressed cells) by applying an address voltage to the turn-on cells. In addition, the sustain period is for causing a discharge for displaying an image by the addressed cells.

In general, a plasma display expresses grayscales of the turn-on cells by controlling the number of sustain-discharge pulses applied during each sustain period according to a weight of each subfield. When a subfield has a high weight, the number of sustain pulse applications are increased so as to express a high grayscale. However, many uncontrollable charges in each electrode of a plasma display panel (PDP) are generated after sustain discharge in a subfield having a high weight. The uncontrollable charges include wall charges that cannot be eliminated even by a reset pulse that is applied during a reset period of the next subfield.

FIG. 1 is a graph depicting the comparative amount of uncontrollable charges that vary from subfield to subfield in one frame.

In FIG. 1, one frame is divided into eight subfields, and each subfield is divided into a reset period (not shown), an address period, and a sustain period. In this case, the amount of uncontrollable charges is larger when a subfield has a high weight. The weights of the eight subfields increase progressively from the first to the eighth subfield. Therefore, the amount of the uncontrollable charges is increased substantially during sustain periods of the seventh subfield and the eighth subfield, and the amount of uncontrollable charges exceeds a threshold value during address periods of the eight subfield located consecutive to the seventh subfield and the first subfield of a following frame that is located consecutive to the eight subfield. As described, when the amount of uncontrollable charges exceeds a threshold value, discharge cells to be turned on are not properly selected during the address period as a result of a weak discharge that is generated during the address period. Particularly, when the temperature of the PDP is high, the weak discharge is generated more often.

### SUMMARY OF THE INVENTION

Embodiments of the present invention provide a plasma display with reduced generation of weak discharge that occurs due to high temperature of the plasma display, and a driving method thereof.

An exemplary method according to one exemplary embodiment of the present invention drives a plasma display during a plurality of subfields divided from a frame, each of the plurality of subfields having a weight. The method includes: detecting temperature of the plasma display, comparing the detected temperature with a reference temperature, and rearranging the plurality of subfields so as to place at least one subfield having a weight that is less than a reference weight between subfields each having a weight that is higher than the reference weight among the plurality of subfields when the detected temperature of the plasma display is greater than the reference temperature. If the subfields satisfy this arrangement, then no rearranging is required and a typical control signal is output.

An exemplary method according to one embodiment of the present invention drives a plasma display during a plurality of subfields divided from one frame, each of the plurality of subfields having a weight. The method includes: detecting temperature of the plasma display and comparing the detected temperature with a reference temperature, detecting a load ratio of at least one subfield among the plurality of subfields from an input video signal of one frame, comparing the detected load ratio with a reference load ratio, and rearranging the plurality of subfields so as to locate at least one subfield having a weight that is less than a reference weight between subfields respectively having a weight that is higher than the reference weight when the detected temperature and the detected load ratio are respectively greater than the reference temperature and the reference load ratio. If the above order of the subfields is satisfied, a rearrangement is not required. Further, if either condition is met and either the detected temperature is higher than the reference temperature or the detected load ratio is higher than the reference load ratio, the plurality of subfields are still rearranged or placed in the above order.

An exemplary plasma display according to one embodiment of the present invention includes a PDP, a temperature detector, a controller, and a driver. The PDP has a plurality of first electrodes, a plurality of second electrodes, and a plurality of discharge cells formed at crossings of the first and second electrodes. The temperature detector detects temperature of the PDP. The plasma display is driven during a plurality of subfields divided from one frame. The controller outputs a control signal to rearrange the plurality of subfields when the detected temperature is greater than a reference temperature, and to obtain a rearranged plurality of subfields. The driver drives the PDP according to the control signal.

In one embodiment, the rearranged plurality of subfields includes a maximized time interval between a first subfield and a second subfield within the overall driving time of the frame. The first subfield has the highest weight and the second subfield has the second highest weight.

### BRIEF DESCRIPTION OF THE DRAWINGS

FIG. 1 is a graph depicting the amount of uncontrollable charges that varies for each subfield within one frame.

FIG. 2 is a schematic plan view of a plasma display according to an exemplary embodiment of the present invention.

FIG. 3 is an operational flowchart of a controller according to a first exemplary embodiment of the present invention.

FIG. 4 is an operational flowchart of a controller according to a second exemplary embodiment of the present invention.

FIG. 5 shows a process for rearranging subfields and the amount of uncontrollable charges that varies for each subfield according to the exemplary embodiment of the present invention.

### DETAILED DESCRIPTION OF THE EMBODIMENTS

Wall charges mentioned in the following description refer to charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage refers to a potential difference formed between the walls of the discharge cell by the wall charge.

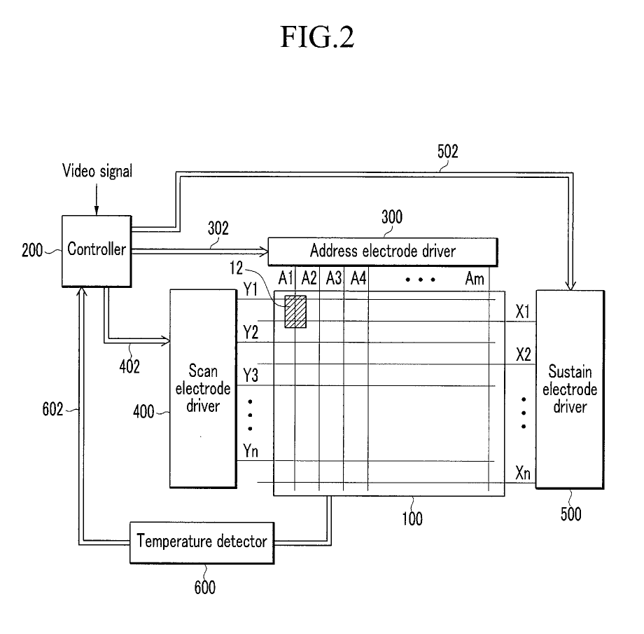

FIG. 2 is a plan view of a plasma display according to an exemplary embodiment of the present invention.

The plasma display according to the exemplary embodiment of the present invention includes a PDP 100, a controller 200, an address electrode driver 300, a scan electrode driver 400, a sustain electrode driver 500, and a temperature detector 600.

The PDP 100 includes a plurality of address electrodes A1 to Am extending in a column direction, and a plurality of sustain electrodes X1 to Xn and a plurality of scan electrodes Y1 to Yn extending in a row direction as pairs. The sustain electrodes X1 to Xn are formed respectively corresponding to the scan electrodes Y1 to Yn, and perform a display operation so as to display an image during a sustain period. The address electrodes A1 to Am are arranged to cross the direction of the sustain electrodes X1 to Xn and the scan electrodes Y1 to Yn. A discharge space in a crossing region of the address electrodes A1 to Am and the scan and sustain electrodes Y1 to Yn and X1 to Xn forms a discharge cell 12. The structure of the PDP 100 is merely exemplary, and panels of other structures can be used in the present invention.

The controller 200 receives external video signals and outputs an address electrode driving control signal, a sustain electrode driving control signal, and a scan electrode driving control signal. The address electrode driving control signal, the sustain electrode driving control signal, and the scan electrode driving control signal are provided from the controller respectively to the address electrode driver 300, the scan electrode driver 400 and the sustain electrode driver 500, through corresponding signal lines 302, 402, and 502. In addition, the controller 200 divides one frame into a plurality of subfields. Each subfield has a reset period, an address period, and a sustain period. The controller 200 according to the exemplary embodiment of the present invention controls each driver 300, 400, 500 to rearrange and control the plurality of subfields when the temperature of the PDP, detected by the temperature detector 600, is greater than a reference temperature.

In addition, the controller 200 may be set to control each driver to rearrange and drive the plurality of subfields only when the temperature of the PDP is greater than the reference value (i.e., reference temperature) and a display light emission ratio is high (i.e., when a load ratio of an input video signal is greater than a reference load ratio).

When rearranging the plurality of subfields, a subfield having a low weight is placed between subfields having a high weight. That is, a subfield during which the amount of uncontrollable charges is increased is located after a subfield during which the amount of uncontrollable charges is decreased. Accordingly, an addressing process for selecting turn-on cells during an address period of each of the plurality of subfields can be performed without being affected by the uncontrollable charges.

The address driver 300 receives the address electrode driving control signal from the controller 200 and applies a display data signal to each address electrode so as to select a discharge cell to be discharged during a subsequent sustain period to display an image.

The scan electrode driver 400 receives the scan electrode driving control signal from the controller 200 and applies a driving voltage to each scan electrode.

The sustain electrode driver 500 receives the sustain electrode driving control signal from the controller 200 and applies a driving voltage to each sustain electrode.

The temperature detector 600 detects the temperature of the PDP 100 and transmits detected temperature to the controller 200 through a temperature signal line 602. The detected temperature is transmitted in the form of a detected temperature signal over the temperature signal line 602.

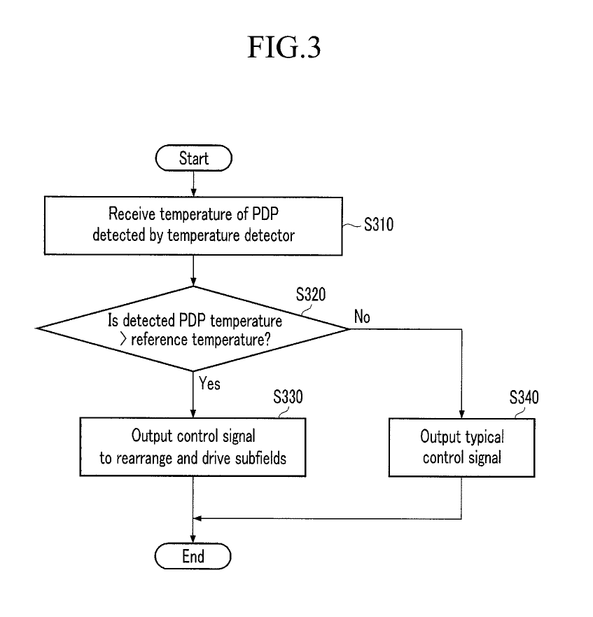

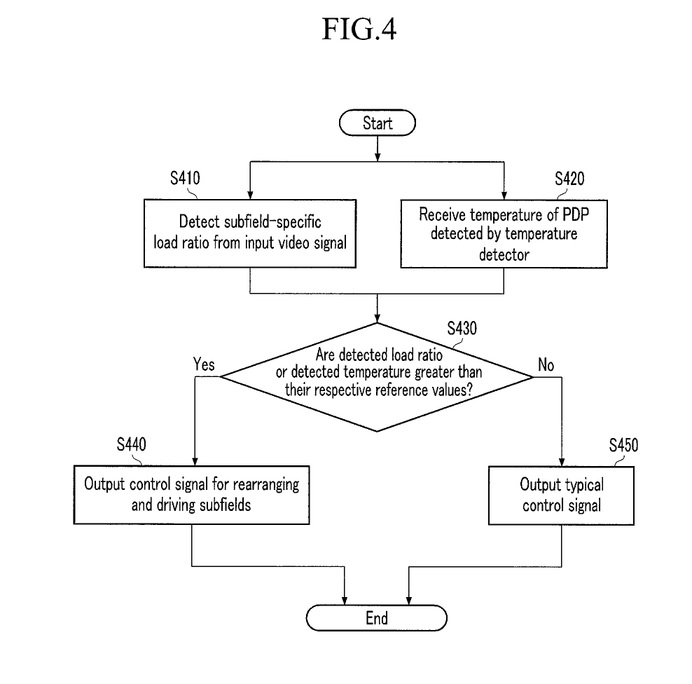

Operation of a controller of the plasma display according to the exemplary embodiment of the present invention will be described with reference to FIG. 3 and FIG. 4.

FIG. 3 is a flowchart of operation of a controller according to a first exemplary embodiment of the present invention.

The controller may be the controller 200 of FIG. 2. The controller receives the temperature of a PDP from a temperature detector in step S310, and compares the detected temperature with a reference temperature in step S320. The temperature detector may be the temperature detector 600 of FIG. 2. The reference temperature may be predetermined.

When the detected temperature is greater than the reference temperature, the controller 200 outputs control signals to the drivers 300, 400, and 500 for rearranging the subfields and driving the plasma display during the rearranged subfields, in step S330. When rearranging the subfields, a subfield having a low weight is placed between subfields having higher weights.

When the detected temperature is less than the reference temperature, the controller 200 outputs typical control signals to the drivers 300, 400, and 500 that result in a typical arrangement of the subfields, in step S340. Herein, when a typical driving waveform is applied, the plurality of subfields divided from one frame are arranged in such a way that the weight of each successive subfield is gradually increased.

The amount of uncontrollable charges is increased while a strong discharge is continuously generated during a sustain period, and is then gradually decreased during a reset period and an address period. Therefore, the plurality of subfields are rearranged when the temperature of the PDP is relatively high so as to prevent the amount of uncontrollable charges from exceeding a threshold level such that the address period cannot be affected by the uncontrollable charges.

A display light emission ratio is high when a load ratio of an input video signal within one frame is high. In this case, when an input video signal has a high load ratio (i.e., high display light emission ratio) it implies that a large number of discharge cells are to be selected as turn-on cells during an address period. For example, a full-white image, having all of the discharge cells selected to be turn-on cells, has the maximum display light emission ratio. In order to display such a full-white image, an address voltage is simultaneously and continuously applied to all of the discharge cells, and therefore the address voltage applied to the discharge cells may experience a strong voltage drop compared to an address voltage applied in other situations where not all of the discharge cells are addressed for a full-white image.

Further, when the input video signal has a high display light emission ratio and the temperature of the PDP is high, an address discharging operation is more significantly affected by the uncontrollable charges. This is because the wall charges that have already been formed may be lost when the discharge cell is selected to be turned on in the latter part of the address period.

That is, when a scan pulse voltage is applied to a scan electrode and an address pulse voltage is applied to an address electrode of a turn-on discharge cell during an address period, a sum of a voltage difference between the scan pulse voltage and the address pulse voltage and a wall voltage that has already been developed in the discharge cell exceeds a discharge firing voltage, generating an address discharge. However, when the display light emission ratio is high, each discharge cell may receive an address pulse voltage that is lower than a normal address pulse voltage.

In addition, when the temperature of the PDP is high, the address discharge is strongly affected by the uncontrollable charges. Therefore, a discharge cell selected to be turned in the latter part of the address period may not experience an address discharge even though a scan pulse voltage and an address pulse voltage are applied to the discharge cell.

In the following detailed description, an operation process of the controller that rearranges subfields in the case that the temperature of the PDP is high and in accordance with a display light emission ratio of a video signal detected within one frame will be described.

FIG. 4 shows an operation of the controller according to a second exemplary embodiment of the present invention.

The controller 200 detects a load ratio of a specific subfield of an input video signal in step S410, and receives the temperature of the PDP detected by a temperature detector in step S420. The temperature detector may be the temperature detector 600 of FIG. 2. In this case, the load ratio of the input video signal can be obtained for each subfield by detecting the number of discharge cells to be turned on for each subfield through subfield data or address data included in video signal data. Herein, a load radio of each subfield is obtained from a ratio of the number of overall discharge cells to the number of light emitting cells (i.e., turn-on cells) of the corresponding subfield.

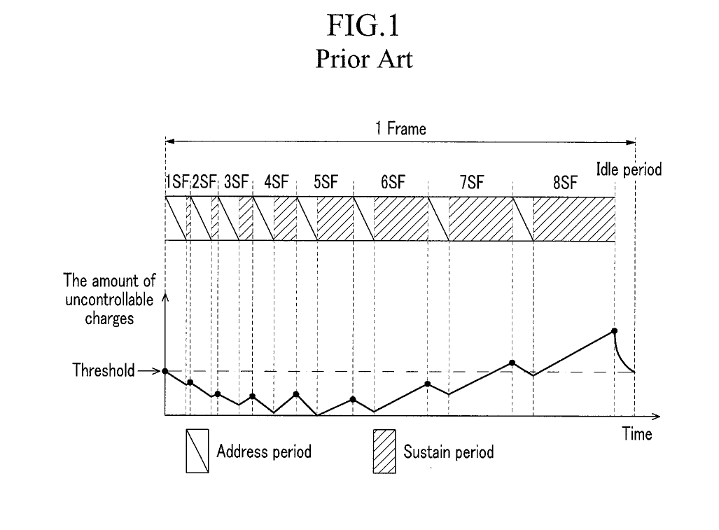

When detecting the number of turn-on discharge cells for each subfield, a load ratio of a specific subfield that has a high possibility of having an amount of uncontrollable charges that is greater than a threshold value is separately obtained. For example, when one frame is divided into eight subfields and driven, the first subfield typically has the minimum weight and the eighth subfield has the maximum weight. In a typical case shown in FIG. 1, the amount of uncontrollable charges exceeds the threshold value while a sustain period of the seventh subfield is being performed, thereby affecting the address period of the eighth subfield.

Subsequently, the amount of uncontrollable charges is reduced during reset and address periods of the eighth subfield and increased again during a sustain period of the eighth subfield. The amount of uncontrollable charges that has been increased during the sustain period of the eighth subfield of one frame may be reduced somewhat, but will increase again, exceeding the threshold value in the first subfield of the next frame. That is, an address period of the first subfield of the next frame will be affected by the uncontrollable charges of the previous frame.

In FIG. 1, an idle period is shown after the first frame and between frames. After all the subfields of one frame are performed, the idle period occurs. A driving waveform is not applied to the electrodes during the idle period.

As described, when a load ratio detected from typically arranged subfields is greater than a reference load ratio, a specific subfield that is more strongly affected by the uncontrollable charges can be experimentally observed. In this case, the specific subfield from which a load ratio is detected may be set to at least one subfield among subfields having a weight that is greater than a reference weight.

The detected load ratio of the specific subfield is compared with the reference load ratio and the detected temperature of the PDP is compared with the reference temperature, in step S430. Herein, the reference load ratio and the reference temperature respectively refer to a load ratio and temperature that cause the amount of uncontrollable charges to exceed the threshold value, thereby affecting an address discharge of an address period of the next subfield. The reference load ratio and the reference temperature can be empirical values.

Step S430 determines whether either the detected load ratio or the detected temperature are greater than their respective reference values. This is a logical OR that includes the condition of when both the detected load ratio and the detected temperature are greater than their respective reference values. When the detected load ratio is greater than the reference load ratio or the detected temperature is greater than the reference temperature, or both conditions are met, a control signal is applied to each of the drivers 300, 400, and 500 of each electrode so as to rearrange the plurality of subfields, in step S440. When rearranging the plurality of subfields, at least one subfield having a low weight is placed between subfields having high weights. As a result, the amount of uncontrollable charges that have been increased during a sustain period of the subfield having the high weight is gradually reduced during a reset period and an address period of the next subfield having the low weight.

During a sustain period of the subfield having the low weight, the amount of the uncontrollable charges is increased slightly. As described, the amount of uncontrollable charges can be maintained below the threshold value by locating at least one subfield having a low weight next to a subfield having a high weight.

When the detected load ratio is less than the reference load ratio or the detected temperature is less than the reference temperature, the controller 200 applies a control signal to the drivers 300, 400, and 500 of the electrodes so as to arrange the plurality of subfields in a typical manner, in step S450. In a typical driving method, one frame is divided into a plurality of subfields and driven. In this case, weights of the subfields within one frame are set to be gradually increased.

As described, when the load ratio of a video signal of one frame is greater than the reference load ratio or the temperature of the PDP is greater than the reference temperature, the plurality of subfields are rearranged and driven such that a weak discharge during an address period of each subfield can be prevented from being generated due to collection of uncontrollable charges.

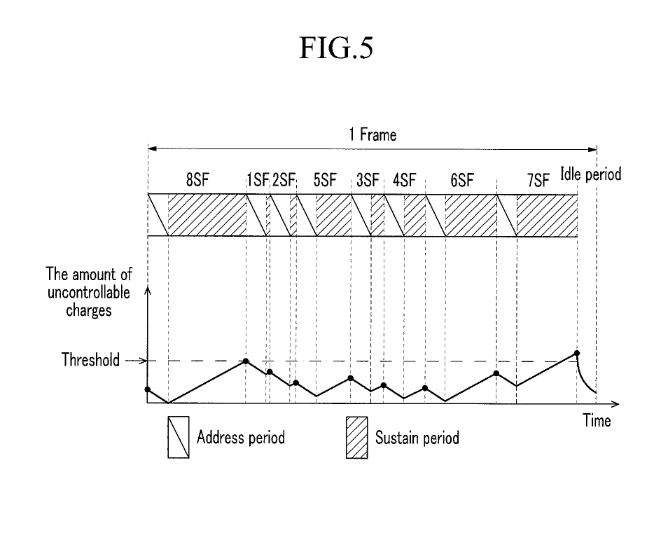

A method for rearranging subfields of the plasma display according to one exemplary embodiment of the present invention will be described with reference to FIG. 5.

FIG. 5 shows a subfield rearranging process of the plasma display and the amount of uncontrollable charges that varies for each subfield according to the exemplary embodiment of the present invention.

FIG. 5 shows a process for rearranging a plurality of subfields when a detected temperature of the PDP is greater than the reference temperature or a load ratio of an input video signal is greater than the reference load ratio as has been described with reference to FIG. 3 and FIG. 4.

In addition, the first subfield SF1 to the eighth subfield SF8 of FIG. 5 have the same weights as those of the subfields used in the description of FIG. 3 and FIG. 4. That is, the plurality of subfields are not numbered in the chronological order that they occur. Rather, they are numbered in accordance with their corresponding weight values. For example, a subfield having a high weight has a high subfield number but may occur early in the frame.

In further detail, at least one subfield having a low weight is located between subfields having high weights so as to prevent the amount of uncontrollable charges from exceeding the threshold value. In this case, the eighth subfield having the highest weight and the seventh subfield having the second highest weight may have the farthest distance from each other with respect to time. The seventh subfield and the eighth subfield have the highest weights and the largest numbers of sustain discharge pulses. Since the amount of uncontrollable charges is increased as the number of sustain discharge pulses applied during a sustain period of each subfield is increased, the eighth subfield and the seventh subfield are prevented from neighboring each other.

In addition, the amount of uncontrollable charges can be maintained below the threshold value by relocating a subfield having a low weight next to a subfield having a high weight so as to prevent the amount of uncontrollable charges from being increased after the subfield having the high weight. Therefore, the amount of uncontrollable charges that has been increased during a sustain period of the subfield having the high weight can be efficiently reduced.

That is, as shown in FIG. 5, operations of the eighth subfield having the highest weight are performed first and operations of the seventh subfield having the second highest weight are performed last so as to maximize the time interval between the two subfields. The first to sixth subfields are arranged between the eighth subfield and the seventh subfield. In this case, after performing the eighth subfield, the first subfield having the lowest weight is performed and then the second subfield having the second lowest weight is performed. In the latter part of a frame, the sixth subfield having a relatively high weight and the seventh subfield are consecutively performed.

Before performing the sixth subfield, the fifth subfield, the third subfield, and the fourth subfield are consecutively performed. In this case, the sixth subfield and the fifth subfield, each having a relatively high weight, are arranged to have the largest time interval within a range between after the eighth subfield is performed and before the seventh subfield is performed.

Accordingly, the amount of uncontrollable charges in an address period of each subfield is maintained below the threshold value from after the eighth subfield to an address period of the seventh subfield. The amount of uncontrollable charges may increase, exceeding the threshold value during a sustain period of the seventh subfield, but at least some of the uncontrollable charges are eliminated during the idle period located at the end of each frame. Therefore, the eighth subfield that is performed first in the next frame is not affected by the uncontrollable charges of the previous frame.

In FIG. 5, the eighth subfield having the highest weight and the seventh subfield having the second highest weight are respectively arranged at the beginning and at the end of the frame. However, the eighth subfield and the seventh subfield can be temporally separated by using another arranging method as long as the amount of uncontrollable charges that increases during a sustain period of either the eighth subfield or the seventh subfield does not affect an address period of the next subfield.

In addition, a subfield having a high weight is defined as a subfield having a weight that is equal to or greater than the reference weight and a subfield having a low weight is defined as a subfield having a weight less than the reference weight. In FIG. 5, the eighth subfield and the seventh subfield are set to have the high weights, and the first to sixth subfields having the low weights are located between the eighth subfield and the seventh subfield. With respect to this arrangement of the subfields, the weight of the seventh subfield is the reference weight. However, the reference weight can be changed. For example, when an address period of a subfield is affected by uncontrollable charges, a weight of the previous subfield can be set to be a reference weight separating the high weights from the low weights.

In addition, although the exemplary embodiment shows that one frame is divided into eight subfields (SF1 to SF8), in other embodiments, one frame can be divided into a different number of subfields and driven.

As described above, a weak discharge due to the uncontrollable charges can be prevented from being generated when the temperature of the PDP is high according to the exemplary embodiment of the present invention. In addition, the amount of uncontrollable charges can be maintained below the threshold value when the temperature of the PDP is high or a load ratio of an input video signal is high, thereby preventing generation of the weak discharge that impairs a succeeding sustain discharge.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display during a plurality of subfields divided from a frame, each subfield of the plurality of subfields having a corresponding weight, the method comprising:
detecting a temperature of the plasma display to obtain a detected temperature;
comparing the detected temperature with a reference temperature; and
placing at least one subfield having a weight less than a reference weight between subfields having a weight greater than the reference weight when the detected temperature is greater than the reference temperature.

2. The method of claim 1, further comprising arranging the subfields to maximize a time interval between a first subfield having the highest weight and a second subfield having the second highest weight within the frame when the detected temperature is greater than the reference temperature.

3. The method of claim 2, further comprising locating a third subfield having the lowest weight consecutive to the first subfield when the detected temperature is greater than the reference temperature.

4. The method of claim 1, wherein an idle period is located between the last subfield of the frame and the first subfield of an immediately following frame.

5. A method for driving a plasma display during a plurality of subfields divided from one frame, each of the plurality of subfields having a corresponding weight, the method comprising:
detecting a temperature of the plasma display to obtain a detected temperature;
comparing the detected temperature with a reference temperature;
detecting, from an input video signal of the one frame, a load ratio of at least one subfield among the plurality of subfields to obtain a detected load ratio;
comparing the detected load ratio with a reference load ratio; and
locating at least one subfield having a weight less than a reference weight between subfields having weights greater than the reference weight when either the detected temperature is greater than the reference temperature or the detected load ratio is greater than the reference load ratio or both.

6. The method of claim 5, wherein the detecting of the load ratio of the at least one subfield includes detecting a load ratio of a subfield having a weight greater than the reference weight.

7. The method of claim 6, further comprising arranging the subfields to maximize a time interval between a first subfield having the highest weight and a second subfield having the second highest weight within an overall time of the frame when either the detected temperature is greater than the reference temperature or the detected load ratio is greater than the reference load ratio or both.

8. The method of claim 7, further comprising locating a third subfield having the lowest weight among the plurality of subfields consecutive to the first subfield when either the detected temperature is greater than the reference temperature or the detected load ratio is greater than the reference load ratio or both.

9. The method of claim 5, further comprising locating an idle period between a last subfield of the one frame and a first subfield of an immediately following frame.

10. A plasma display being driven during a plurality of subfields divided from one frame, the plasma display comprising:
a plasma display panel having a plurality of first electrodes, a plurality of second electrodes, and a plurality of discharge cells formed at crossing regions of the first electrodes and the second electrodes;
a temperature detector for detecting a temperature of the plasma display panel to obtain a detected temperature;
a controller for outputting a control signal for rearranging the plurality of subfields when the detected temperature is greater than a reference temperature; and
a driver for driving the plasma display panel responsive to the control signal to obtain a rearranged plurality of subfields.

11. The plasma display of claim 10, wherein the rearranged plurality of subfields includes a maximized time interval between a first subfield and a second subfield within the one frame, the first subfield having the highest weight and the second subfield having the second highest weight.

12. The plasma display of claim 11, wherein the rearranged plurality of subfields further includes a third subfield having the lowest weight positioned immediately after the first subfield.

13. The plasma display of claim 10, wherein the controller provides an idle period between a last subfield of the one frame and a first subfield of an immediately following frame.

14. The plasma display of claim 12, wherein the controller detects a load ratio of a specific subfield among the plurality of subfields from an input video signal of the frame, and outputs the control signal to obtain the rearranged plurality of subfields when either the detected temperature is greater than a reference temperature or the detected load ratio is greater than a reference load ratio or both.

15. The plasma display of claim 14, wherein the rearranged plurality of subfields includes the maximized time interval between the first subfield and the second subfield when either the detected temperature is greater than the reference temperature or the detected load ratio is greater the reference load ratio or both.

16. The plasma display of claim 10,
wherein the plasma display panel includes a plurality of third electrodes located parallel to the plurality of first electrodes, and
wherein the driver includes a first driver for driving the plurality of first electrodes, a second driver for driving the plurality of second electrodes and a third driver for driving the plurality of third electrodes.

17. The plasma display of claim 10, wherein the frame includes N subfields (N is a natural number),
wherein the weight of each subfield increases from a first subfield to a Nth subfield, and
wherein the subfields are arranged within the frame consecutively in time from the first subfield to the Nth subfield in an order of increasing weight.

18. The plasma display of claim 17, wherein the rearranged plurality of subfields provides the Nth subfield at a beginning of the frame and a N-1th subfield at an end of the frame.

19. The plasma display of claim 18, wherein the rearranged plurality of subfields provides the first subfield following the Nth subfield.
